(19) United States
(12) Patent Application Publication
(10) Pub. No.: US 2025/0185143 A1
(43) Pub. Date: Jun. 5, 2025

(54) Multi-Die Tunable-White LED Apparatus

(71) Applicant: Karl S. Jonsson, Rancho Santa Margarita, CA (US)

(72) Inventor: Karl S. Jonsson, Rancho Santa Margarita, CA (US)

(21) Appl. No.: 18/964,601

(22) Filed: Dec. 1, 2024

Related U.S. Application Data
(60) Provisional application No. 63/605,341, filed on Dec. 1, 2023.

(51) Int. Cl. H05B 47/155; F21K 9/64; F21S 4/24; F21Y 115/10; H05B 45/10; H05B 45/20; H05B 45/37

(52) U.S. Cl. CPC H05B 47/155; F21K 9/64; F21S 4/24; H05B 45/10; H05B 45/20; H05B 45/37; F21Y 2115/10

(57) ABSTRACT

A device includes a first light-emitting subassembly to emit light at a first correlated color temperature (CCT) comprising a first phosphor and a first light-emitting device positioned to excite the first phosphor. The device also includes a second light-emitting subassembly to emit light at a second CCT comprising a second phosphor and a second light-emitting device positioned to excite the second phosphor. The device also includes a third light-emitting device to emit light at a third CCT. The device may also include a control circuit configured to provide first controlled power to the first light-emitting device, second controlled power to the second light-emitting device, and third controlled power to the third light-emitting device. The device includes one or more inputs to the control circuit to provide power, brightness information, and target color temperature information to the control circuit.

### CROSS-REFERENCE TO RELATED APPLICATIONS

This application claims the benefit of U.S. Provisional Application 63/605,341 filed Dec. 1, 2023.entitled “Multi channel Tunable White LED for Twilight Simulation and Low Color Temperatures,” which is hereby incorporated by reference in its entirety herein for any and all purposes.

### TECHNICAL FIELD

The present subject matter relates to LED lighting and more specifically, to adjusting the color temperature for LED lighting.

### BACKGROUND

White light emitted by LED chips is typically generated through the use of sapphire or silicone substrate LED emitters in blue, which excite a mixed phosphor or yttrium aluminum garnet (YAG) to produce a broad-spectrum white light. The quality and characteristics of the white light, including color temperature and color rendering index (CRI), are determined by the phosphor mix. Some LEDs use gallium nitride on gallium nitride (GaN on GaN) substrates emitting UV light outside the visible spectrum, combined with special phosphors, to achieve zero blue, high-quality white light.

Tunable White LED technology allows for the adjustment of color temperature, enabling various settings, such as concentration or relaxation. Applications also extend to Human Centric Lighting, where color temperature shifts over time according to circadian rhythms for health-related benefits.

Current state-of-the-art tunable white LED strips typically facilitate fading between two fixed color temperatures, such as 2700K or 3000K (Warm light) and 6000K or 6500K (Cold light). However, achieving a smooth transition between color temperatures below 3000K poses a challenge due to the curved nature of the Planckian locus. Existing solutions may result in an artificial appearance.

### BRIEF DESCRIPTION OF THE DRAWINGS

The accompanying drawings, which are incorporated in and constitute part of the specification, illustrate various embodiments. Together with the general description, the drawings serve to explain various principles. In the drawings:

FIG. 1A shows an example multi-die tunable-white light-emitting diode (LED) apparatus;

FIG. 1B shows an alternative example multi-die tunable-white light-emitting apparatus;

FIG. 2 shows a block diagram of an example system using the multi-die LED apparatus of FIG. 1A;

FIG. 3 shows a block diagram of an alternative example system using a multi-die tunable-white LED strip;

FIG. 4 shows a block diagram of an alternative example LED strip using the multi-die LED apparatus of FIG. 1B;

FIG. 5 shows example transfer functions for the four channels of the multi-die tunable-

white LED of FIG. 1A or 1B;

FIG. 6 shows an example of controlling the multi-die tunable-white LED of FIG. 1A or 1B

FIG. 7 shows example transfer functions for of an example seven-channel multi-die wide-range tunable-white LED; and

FIG. 8 shows two flow charts that together describe an example method of controlling a multi-die tunable-white LED.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

A novel approach to tunable white LEDs is described herein. Multiple phosphors are employed using separate LEDs or a multi-die LED chip. Examples of a multi-die LED chip include, but are not limited to, a 5050 LED (5.0 mm×5.0 mm substrate with multiple LED die) or a Chip-on-Board (COB) LED. In a specific embodiment, a 3-split 5050 chip incorporates three sections, each having a blue or UV LED die and a different phosphor, such as 3200K, 2500K, and 1800K. Additionally, a deep red LED die at around 700 nm is placed behind the warmest phosphor (e.g., the 1800K phosphor) or without a phosphor to achieve the fourth and warmest red glow color temperature.

A 4-channel PWM controller is employed to control the gradual dimming between the phosphors, effectively simulating the twilight part of a sunset. A simplified 2-channel interface may be used which abstracts the 4-channel mapping by having a first channel to control a brightness level (i.e., dimming) and a second channel to control a color temperature. The controller then maps the target color temperature to two of the LEDs and controls the relative drive levels of those two LED to achieve the target color temperature. The target brightness level is also used to modulate the driver levels of the two LEDs to achieve the target brightness.

One aspect of this system is its application in power-constrained scenarios, such as LED strips with limitations imposed by thin copper in the flexible PCB. The LED density and power can be exceeded by a factor of 3x, as only two LED channels are active at any given time during the cycle of the four channels. For instance, to achieve a color temperature of 2850K, the 3200K and 2500K channels would be at 50%, while the other two channels (1800K and 700 nm/1000K) remain off.

Systems built as described herein may find utility in artistic installations, including art pieces, restaurant accent lighting, high-end residential spaces, and hospitality settings, although it could be used in any environment where color-tunable lighting is desirable.

The disclosed implementations address a limitation of existing tunable white LED technology by providing a solution for smooth transitions between lower color temperatures, particularly beneficial in artistic and high-end lighting applications. The unique combination of multiple phosphors, controlled by a sophisticated PWM controller, allows for a realistic simulation of the twilight part of a sunset and other warm accent lighting features.

Reference now is made in detail to the examples illustrated in the accompanying drawings and discussed below.

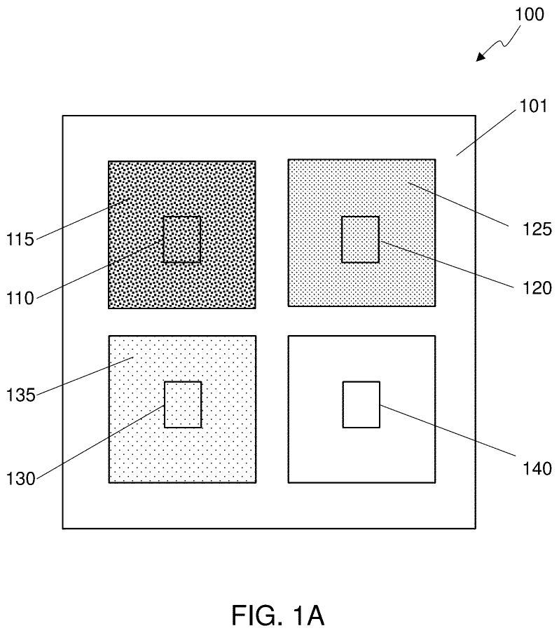

FIG. 1A shows an example multi-die tunable-white light-emitting diode (LED) apparatus 100. The multi-die LED 100 includes four LED die 110, 120, 130, and 140 mounted on a substrate 101. The first LED die 110 is located in a position to excite a first phosphor 115. The second LED die 120 is located in a position to excite a second phosphor 125. The third LED die 130 is located in a position to excite a third phosphor 135. The first LED die 110, the second LED die 120, and the third LED die 130 emit a light suitable to excite the phosphors 115, 125, 135, such as blue light or ultraviolet (UV) light. The fourth LED die 140 emits red light, such as about 700 nm or about 1000K and is positioned to not be behind a phosphor as shown in FIG. 1A, allowing the light from the fourth LED die 140 to emit from the LED apparatus 100.

The multi-die LED 100 includes contact points (not shown in FIG. 1A) to allow the four LED die 110, 120, 130, 140 to be independently driven. It may have separate connects for both the anode and cathode of each of the four LED die 110, 120, 130, 140 for a total of 8 contacts, or it may have 5 contacts where the four LED die 110, 120, 130, 140 share either a common cathode or a common anode.

The three different phosphors 115, 125, 135 are selected to emit light at different color temperatures. In one implementation, the first phosphor 115 emits light at about 3200K, the second phosphor 125 emits light at about 2500K, and the third phosphor emits light at about 1800K. Many other implementations are possible, such as 10000K, 6000K, 4400K, and 2700K.

Other implementations may include different numbers of LED die on the multi-die LED, some of which may be coupled to phosphors and some which are not, to emit light having different color temperatures, such as three LEDs with two coupled to phosphors and one without a phosphor, or 7 LEDs, all but one of which are coupled to different phosphors. Other alternatives are also possible, with any number of LEDs with associated phosphors and additional LEDs without phosphors, depending on the implementation.

FIG. 1B shows an alternative example multi-die tunable-white light-emitting apparatus 150. The apparatus 150 includes a first light-emitting subassembly 160 to emit light at a first correlated color temperature (CCT) and including a first phosphor 165 and a first light-emitting device 163, such as a first LED die, positioned to excite the first phosphor 165. The apparatus 150 also includes a second light-emitting subassembly 170 to emit light at a second CCT and including a second phosphor 175 and a second light-emitting device 173, such as a second LED die, positioned to excite the second phosphor 175. In addition, the apparatus 151 includes a third light-emitting subassembly 180 including a third phosphor 185 to emit light a third CCT, a third light-emitting device 183, such as a third LED die, positioned to emit light to excite the third phosphor, and a fourth light-emitting device 184, such as a fourth LED die, to emit light at a fourth CCT.

Thus, the apparatus 150 may include four LED die 163, 173, 183, and 184 mounted on a substrate 151. Any appropriate substrate may be used, but in at least one implementation, the substrate 151 is a 5050 surface-mount device (SMD) package. The first LED die 163, the second LED die 173, and the third LED die 183 emit a light suitable to excite the phosphors 165, 175, 185, such as blue light or ultraviolet (UV) light. The fourth LED die 184 emits red light, such as about 700 nm or about 1000K and while it is positioned behind the third phosphor 185 as shown in FIG. 1B, the third phosphor 185 is formulated to allow the red light to pass through, and not activate the third phosphor 185. This allows the apparatus 150 to have four separate emission characteristics, three from the three different phosphors 165, 175, 185 and one from the fourth LED die 184, from a three-cavity substrate 151.

The three different phosphors 115, 125, 135 are selected to emit light at different correlated color temperatures (CCT) and to be activated by the wavelength of the light emitted from the first three LEDs 163, 173, 183, such as UV or blue light. The first phosphor 165 may be formulated to filter the light received from the first light-emitting device 163, the second phosphor 175 may be formulated to filter the light received from the second light-emitting device 173, and the third phosphor 185 may be formulated to filter the light received from the third light-emitting device 183 and pass the light received from the fourth light emitting device 184. In one implementation, the first phosphor 115 emits light at about 3200K when activated by the light from the first LED 163, the second phosphor 125 emits light at about 2500K when activated by the light from the second LED 173, and the third phosphor emits light at about 1800K when activated by the light from the third LED 183. Many other implementations are possible, using phosphors that emit light at other CCTs, such as 10000K, 6000K, 4400K, and 2700K.

The apparatus 150 includes a control circuit 190 mounted on the substrate 151 and configured to provide first controlled power to the first light-emitting device 163, second controlled power to the second light-emitting device 173, third controlled power to the third light-emitting device 183, and fourth controlled power to the fourth light-emitting device 184. It also includes two or more electrical contacts (not shown in FIG. 1B) to provide power, brightness information, and target color temperature information to the control circuit 190.

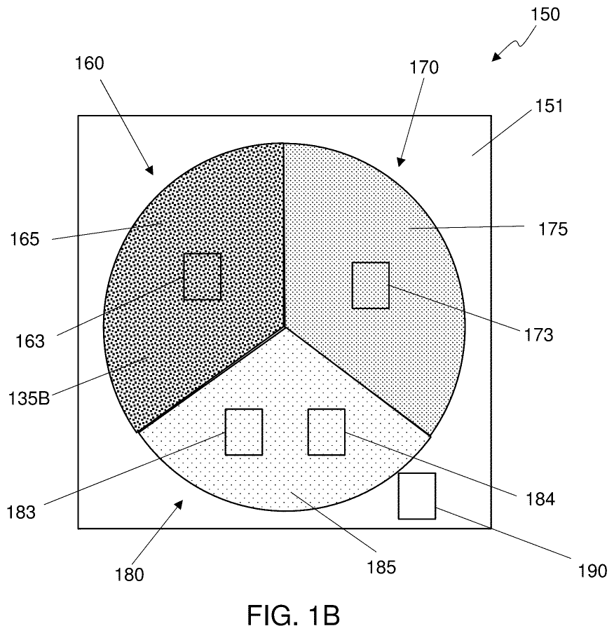

FIG. 2 shows a block diagram of an example system 200 using the multi-die LED 100 of FIG. 1A. It includes a light-emitting apparatus 100, which includes a first light-emitting subassembly 118 to emit light at a first correlated color temperature (CCT) that has a first phosphor 115 and a first light-emitting device 110 positioned to excite the first phosphor 115. The apparatus 100 also includes a second light-emitting subassembly 128 to emit light at a second CCT that has a second phosphor 125 and a second light-emitting device 120 positioned to excite the second phosphor 125. In addition, the apparatus 100 also includes a third light-emitting subassembly 138 to emit light at a third CCT that has a third phosphor 135 and a third light-emitting device 130 positioned to excite the third phosphor 135. A fourth light-emitting device 140 to emit light at a fourth CCT is also included in the apparatus 100.

The system 200 also includes a control circuit 210 configured to provide first controlled power to the first light-emitting device 110, second controlled power to the second light-emitting device 120, third controlled power to the third light-emitting device 130, and fourth controlled power to the fourth light-emitting device 140. The controller 210 also includes one or more inputs to provide power, brightness information, and target color temperature information to the control circuit 210. It may receive any number of control inputs, such as the two control inputs as shown, a dimming (or target brightness) control input 212 and a target color temperature control input 214.

The controller 210 receives the control inputs 212, 214 and determines which two LED die should be used to generate the target color temperature. For example, if the target color temperature control input 214 indicates a color temperature of 2850K, then the second LED die 120 coupled to the second phosphor 125 that emits light at 3200K and the third LED die 130 coupled to the third phosphor 135 that emits light at 2500K may be driven at equal levels based on the target dimming level indicated by the dimming control input 212. The first LED die 110 and the fourth LED die 140 would be completely off in this example.

The controller 210 determines the first controlled power, the second controlled power, the third controlled power, and the fourth controlled power based on the brightness information received through the brightness input 212, the target color temperature information received through the color temperature input 214, the first CCT, the second CCT, the third CCT, and the fourth CCT. The controller 210 may also take various other parameters into account when determining the drive levels of the four LED die 110, 120, 130, 140 such as, but not limited to, efficiencies of the phosphors 115, 125, 135, linearity and efficiency of the LED die 110, 120, 130, 140, gamma curves, or any other appropriate factor. The controller 210 may use pulse-width modulation (PWM), pulse frequency modulation (PFM), current amplitude modulation, or any other appropriate modulation method to control the output of the four LED die 110, 120, 130, 140, including a combination of PWM and current amplitude modulation. The controller 210 may have separate anode and cathode connections for each LED die 110, 120, 130, 140 as shown in FIG. 2, or may use a common anode or common cathode configuration.

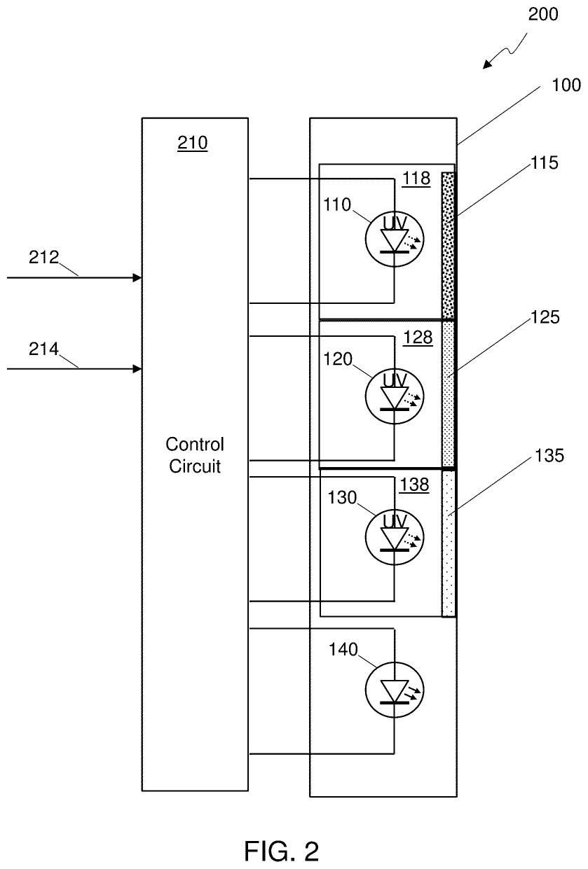

FIG. 3 shows a block diagram of an alternative example system 300 using a multi-die tunable-white LED strip, a section 310 of which is shown, a controller 350, and one or more inputs to provide power, brightness information, and target color temperature information to the system 300. The one or more inputs may include a brightness input 302, a color temperature input 303, and a power input 301 which may include both a power and ground input, or may just a common anode 301 (as shown) or a common cathode for the brightness input and the color temperature input which may be pulse-width modulated (PWM) to respectively provide the brightness information and the target color temperature information to the control circuit. If only a single power rail is provided, a circuit 304 may be included to generate the other power rail. The circuit 304 uses the common anode 301 connected to a capacitor 305 as Vcc for the controller 350 and provides Vss to the controller 350 using a first diode 306 with its cathode connected to the brightness input 302 and a second diode 307 with its cathode connected to the color temperature input 303. The anodes of the diodes 306,307 are connected to Vss of the controller 350 and the capacitor 305. Protocol may provide for a maximum duty cycle of the PWM on at least one of the inputs 302, 303 to ensure that Vss can be successfully generated.

The LED strip may have any number of sections, which may be copies of section 310 which are connected to each other in series. In the example shown, the section 310 includes three sets of LEDs 320, 330, 340, although any number of sets of LEDs may be included, depending on the implementation. Other implementations may mount one or more sets of LEDs on a different type of material or in a bulb or luminaire.

The first set of LEDs 320 includes a first LED with phosphor 321 which emits light with a first CCT, a second LED with phosphor 322 which emits light with a second CCT, and a third LED 323 that emits light at a third CCT without a phosphor. The second set of LEDs 330 includes a first LED with phosphor 331 which emits light with the first CCT, a second LED with phosphor 332 which emits light with the second CCT, and a third LED 333 that emits light the third CCT without a phosphor. The third set of LEDs 340 includes a first LED with phosphor 341 which emits light with the first CCT, a second LED with phosphor 342 which emits light with the second CCT, and a third LED 343 that emits light the third CCT without a phosphor. Other implementations may have any number of LEDs with or without phosphors that emit light at various CCTs. In some implementations, all of the LEDs in a set are coupled to a phosphor. In at least one implementation, the three LEDs in a set are a red LED, a green LED, and a blue LED, without any phosphors.

The controller 350 for the system 300 is shown as being separate from the section 310 of the LED strip although other implementations may include a controller 350 on each section 310 of the LED strip. In the configuration shown in FIG. 3, the controller 350 can drive multiple sections of the LED strip, where the number of sections it can drive is dependent upon its power delivery capability, which may vary between implementations. The controller 350 includes one or more inputs 351 to provide brightness information, and target color temperature information, such as brightness input 302 and target color temperature input 303. It also includes outputs 353 to drive the section 310 of the LED strip.

The controller 350 includes a converter 356 to generate a first power level, a second power level, and a third power level based on the brightness information, the target color temperature information, a first light-emitter characteristic, a second light-emitter characteristic, and a third light-emitter characteristic. The first light-emitter characteristic may include the first CCT of the first LEDs with phosphor 321, 331, 341, the second light-emitter characteristic may include the second CCT of the second LEDs with phosphor 322, 332, 342, and the third light-emitter characteristic may include the third CCT of the third LEDs 323, 333,343. In some implementations, the first light-emitter characteristic, the second light-emitter characteristic, and the third light-emitter characteristic each further include efficiency information for the LEDs and/or phosphors 321-343. The efficiency information may be in the form of a representation of a curve providing light output in response to a power input level or a current level. In some implementations, the first light-emitter characteristic, the second light-emitter characteristic, and the third light-emitter characteristic each include a spectral wavelength and efficiency information and/or the first light-emitter characteristic indicates a red LED emission, the second light-emitter characteristic indicates a green LED emission, and the third light-emitter characteristic indicates a blue LED emission.

The outputs 353 include a first output A to provide a first power signal to a first control input 318 of the section 310 of the LED strip based on the first power level, a second output B to provide a second power signal to a second control input 316 of the LED strip based on the second power level, and a third output C to provide a third power signal to a third control input 314 of the LED strip based on the third power level. The converter 356 may limit a sum of the first power level, the second power level, and the third power level to a predetermined maximum to ensure that power limitations of the LED strip are not exceeded. The three control inputs 314, 316, 318 of the section 310 of the LED strip share a common anode input 312 which is connected to the common anode input 301 of the system 300.

The converter 356 may use any appropriate technique to determine the power levels, depending on the implementation and on the light emitter characteristics. For example, if the three light emitter characteristics indicate that LED strip uses red, green, and blue LEDs, the converter 356 may map the target color temperature to an RGB value using lookup tables with or without interpolation, or one or more equations that piece-wise map ranges of CCT to RGB values such as those disclosed in tannerhelland.com/2012/09/18/convert-temperature-rgb-algorithm-code.html, which is incorporated by reference herein. In the equations disclosed on that website, red values below 6600K are set to 100% with an exponential equation used to generate a red value for a CCT above 6600K. Blue values above 6500K are set to 100% with a logarithmic equation used to generate a blue value for a CCT below 6500K. A logarithmic equation is used to generate a green value for a CCT below 6600K and an exponential equation is used to generate a green value for a CCT value above 6600K.

As another example, if the three light emitter characteristics indicate a set of CCT values, the converter 356 may determine that the target color temperature information is between the first CCT and the second CCT and in response, generate a third power level of 0 and a first power level and a second power level based on the target color temperature information, the first CCT, and the second CCT, without use of the third CCT. This may be done based on a linear interpolation of the target color temperature information between the first CCT and the second CCT.

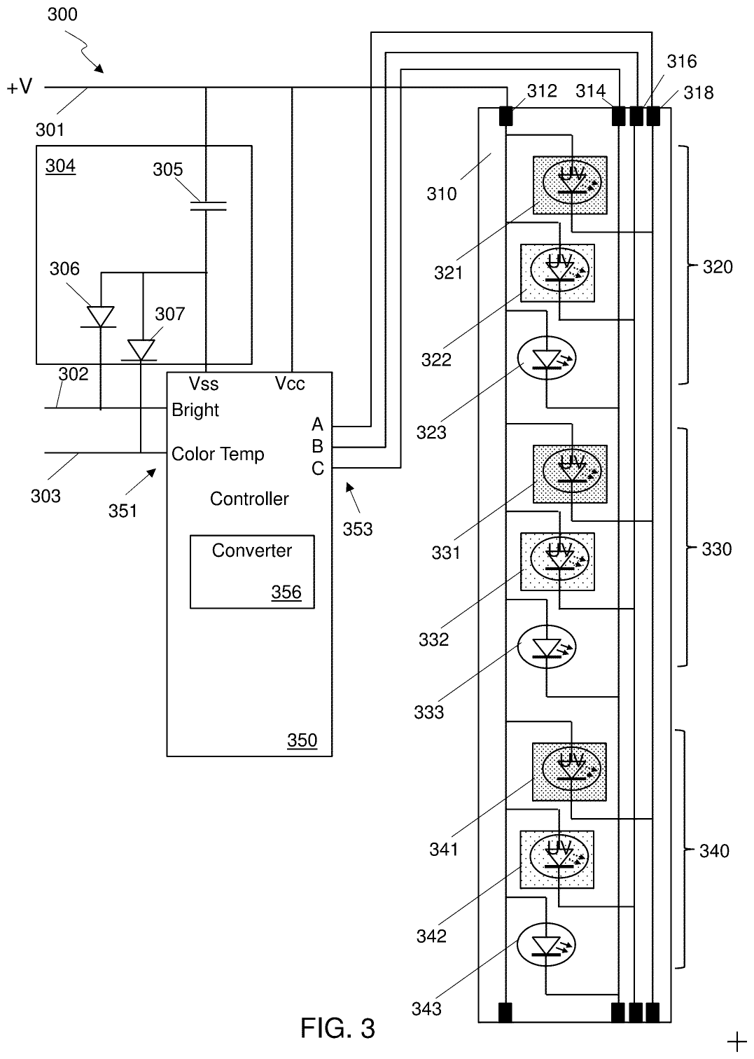

FIG. 4 shows a block diagram of an alternative example LED strip 400 using the multi-die LED apparatus of FIG. 1B, the section of the LED strip 400 shown includes 6 multi-die LED apparatus 410A, 410B, 410C, 410D, 410E, 410F that are mounted on a strip of flexible material. Each LED apparatus 410A, 410B, 410C, 410D, 410E includes four LED die. The LED die of the apparatus 410A are shown as the first LED die 411A which excites a first phosphor (which together may be referred to as a first light-emitting subassembly), the second LED die 412A which excites a second phosphor (which together may be referred to as a second light-emitting subassembly), the third LED die 413A which excites a third phosphor, and a fourth LED die 414A which has its light passed through the third phosphor without activating the third phosphor. Each LED apparatus, 410A-410F also includes a controller, such as controller 415A of the first apparatus 410A. Thus, the first light-emitting subassembly, the second light-emitting subassembly, the third light-emitting device, and the control circuit are affixed to the strip of flexible material.

The LED strip 400, or light-emitting apparatus, includes a serial input 426 to provide the brightness information and the target color temperature information, a power input 424, and a ground input 422. The serial input 426 may use any serial protocol to provide the brightness (or dimming) information and the target color temperature information, including, but not limited to, serial peripheral interface (SPI), inter-integrated circuit (I²C), universal serial bus (USB), or a proprietary protocol based on RS-232 or RS-485. The serial input 426 may broadcast data to each device connected to the serial input 426 or the serial input 426 may utilize a protocol where data is addressed to a specific device. In some implementations, the serial input may be daisy-chained between the devices, so that each device receives data on a serial input and then sends data on a serial output to the serial input of the next device, so that the serial input of the section 426 is only connected to the controller 415A of the first LED apparatus 410A and controller 415A then passes all or some of the data received on to the controller of the second LED apparatus 410B.

The controller of each LED apparatus generates power signals for each of its respective LEDs based on the brightness information and the target color temperature information received through the serial interface. The power signals also depend on characteristics of the LED apparatus 410A-F, such as the CCT and efficiency information for each of the 4 light sources in the LED apparatus. The characteristics may be hard-wired into a controller, programmed into the controllers as a part of the manufacturing process, programmed into the controller through the serial interface and stored into volatile or non-volatile memory in the controller as a part of an installation procedure or by a user, or set by any other appropriate mechanism.

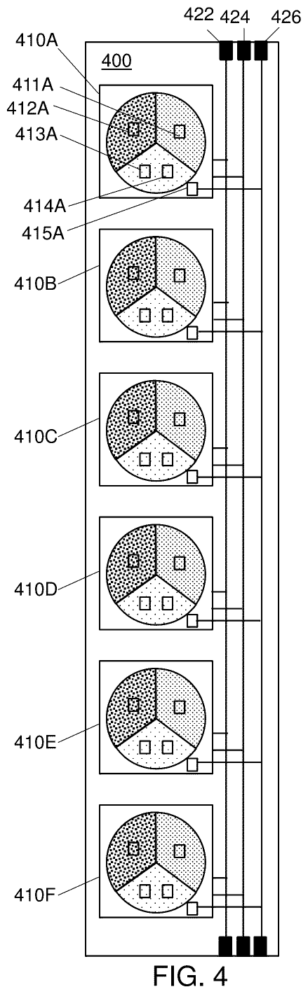

FIG. 5 shows example transfer functions 500 for the four channels of the multi-die tunable-white LED of FIG. 1A or 1B having a first light-emitting assembly that emits light at 3200K, a second light-emitting assembly that emits light at 2500K, a third light-emitting assembly that emits light at 1800K and a fourth light-emitting device that emits light at 1000K. The x-axis represents target color temperature and the y-axis represents a power level. The four transfer functions 510-540 show the power level, assuming linear response for the light-emitters for this example, for the four channels of the multi-die tunable-white LED. The first transfer function 510 shows the power provided to the first light-emitting subassembly depending on the target color temperature. The power for the first light-emitting subassembly is only non-zero for target color temperatures between 2500K and 3200K, with no power provided to the first light-emitting subassembly for target color temperatures below 2500K, the CCT of the second light-emitting subassembly. The second transfer function 520 shows the power provided to the second light-emitting subassembly depending on the target color temperature. The power for the second light-emitting subassembly is non-zero for target color temperatures between 1800K, the CCT of the third light-emitting subassembly, and 3200K, the CCT of the first light-emitting subassembly, with no power provided to the second light-emitting subassembly for target color temperatures outside of that range. The third transfer function 530 shows the power provided to the third light-emitting subassembly depending on the target color temperature. The power for the third light-emitting subassembly is non-zero for target color temperatures between 1000K, the CCT of the fourth light-emitting subassembly, and 2500K, the CCT of the second light-emitting subassembly, with no power provided to the third light-emitting subassembly for target color temperatures outside of that range. The fourth transfer function 540 shows the power provided to the fourth light-emitting subassembly depending on the target color temperature. The power for the fourth light-emitting subassembly is only non-zero for target color temperatures between 1000K and 1800K, with no power provided to the fourth light-emitting subassembly for target color temperatures above 1800K, the CCT of the third light-emitting subassembly.

Note that if the different light-emitting subassemblies have different efficiencies, the peak power might be different for the various transfer functions 510-540. Also, if the brightness response for the light-emitting subassemblies is not linear, the transfer functions may not be linear. These characteristics may be taken into account by implementations of a controller.

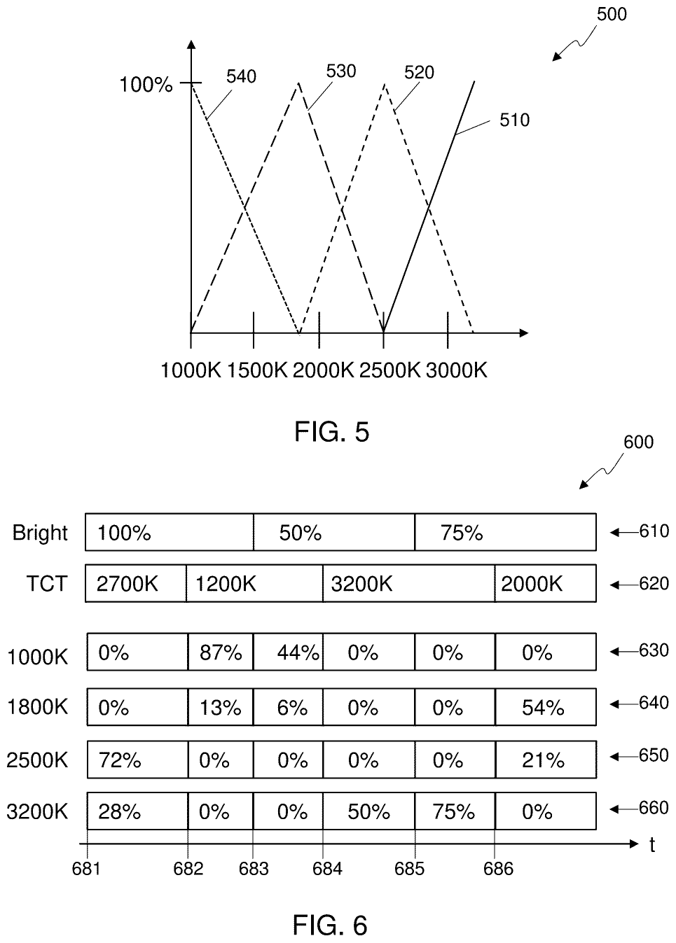

FIG. 6 shows an example of controlling the multi-die tunable-white LED of FIG. 1A or 1B with the transfer functions represented in FIG. 5. The x-axis represents time. Row 610 shows the values (or information) received for brightness by the controller on the one or more inputs and row 620 shows the value (or information) received for target color temperature (TCT) by the controller on the one or more inputs. The values are shown in a human readable format, but the information may be encoded onto the one or more inputs using any appropriate mechanism, including, but not limited to, PWM encoding of a percentage of full range of the values (e.g. mapping 3200K to 100% for TCT), binary encoding of the values, or using an analog voltage to represent the values.

The brightness and TCT are set to 100% and 2700K, respectively at time 681. The controller uses those values, along with information about the light emitting apparatus such as CCT and efficiency of each light-emitting subassembly, to determine what power level should be provided to each light-emitting device. For the purposes of this example, each light-emitting subassembly is assumed to have identical linear efficiency characteristics, but real-world devices likely will have non-linear characteristics with different efficiency between light-emitting subassemblies. So, at time 681, the controller determines that the TCT is between the CCTs of the first and second light-emitting subassemblies. In response, it turns off the power to the fourth light-emitting subassembly that emits light at 1000K as shown in row 630 and to the third light-emitting subassembly that emits light at 1800K as shown in row 640. It then uses linear interpolation using the TCT between 2500K and 3200K to determine that a 72% power level should be sent to the second light-emitting subassembly that emits light at 2500K (as shown in row 650 and a 28% power level should be sent to the first light-emitting subassembly that emits light at 3200K as shown in row 660. Note that with the brightness input at 100%, the sum of power levels equals 100%.

At time 682, the TCT 620 changes to 1200K so the controller determines that the TCT is now between 1000K (the CCT of the fourth light-emitting device) and 1800K (the CCT of the third light-emitting subassembly), so it sets the power levels 660, 650 for the first light-emitting subassembly and the second light-emitting subassembly to 0% and linearly interpolates between 1000K and 1800K using the TCT of 1200K to set the power level 630 for the fourth light emitting device to 87% and the power level 640 for the third light-emitting device to 13%, keeping the sum of the power levels equal to the brightness level of 100%.

At time 683, the brightness 610 changes to 50% without any change to the TCT 620, so the controller cuts the power level 630 for the fourth light emitting device to 44% and the power level 640 for the third light-emitting device to 6%, keeping the sum of the power levels equal to the new brightness level of 50%.

At time 684, the TCT 620 changes to 3200K. The controller determines that the TCT 620 equals the CCT of the first light-emitting subassembly so uses the brightness 610 of 50% to set the power level 660 for the first light-emitting subassembly to the same 50% value and sets the other power levels 630, 640, 650 to 0%. At time 685, the brightness 610 changes to 75% without any change to the TCT 620, so the controller changes the power level 660 for the first light emitting device to 75% to match the brightness 610, leaving the other power levels 630, 640, 650 at 0%

At time 686, the TCT 620 changes to 2000K. The controller determines that the TCT 620 is between the second and third CCTs. In response, it sets the first power level 660 and the fourth power level 630 to 0% and interpolates between the second and third CCTs using the TCT 620 to determine that the second power level 650 is 21% and the third power level 640 is 54%, which add up to the 75% brightness 610.

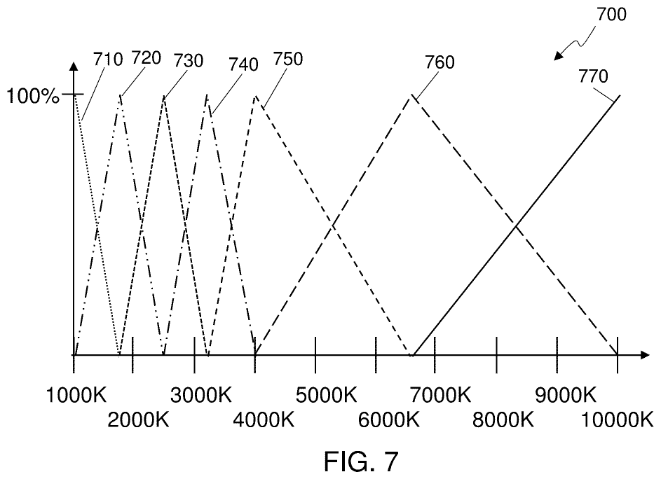

FIG. 7 shows example transfer functions 700 for of an example seven-channel multi-die wide-range tunable-white LED which has a first light-emitting subassembly that emits light with a CCT of 1000K, a second light-emitting subassembly that emits light with a CCT of 1800K, a third light-emitting subassembly that emits light with a CCT of 2500K, a fourth light-emitting subassembly that emits light with a CCT of 3200K, a fifth light-emitting subassembly that emits light with a CCT of 4000K, a sixth light-emitting subassembly that emits light with a CCT of 6600K, and a seventh light-emitting subassembly that emits light with a CCT of 10000K. A light-emitting apparatus consistent with this disclosure may have any number of light-emitting subassemblies that emit light with any combination of CCTs.

The x-axis in FIG. 7 represents target color temperature and the y-axis represents a power level. The seven transfer functions 710-770 show the power level, assuming linear response for the light-emitters for this example, for the seven channels of the multi-die tunable-white LED. Thus, the first transfer function 710 shows the power provided to the first light-emitting subassembly depending on the target color temperature. The second transfer function 720 shows the power provided to the second light-emitting subassembly depending on the target color temperature. The third transfer function 730 shows the power provided to the third light-emitting subassembly depending on the target color temperature. The fourth transfer function 740 shows the power provided to the fourth light-emitting subassembly depending on the target color temperature. The fifth transfer function 750 shows the power provided to the fifth light-emitting subassembly depending on the target color temperature. The sixth transfer function 760 shows the power provided to the sixth light-emitting subassembly depending on the target color temperature, and the seventh transfer function 770 shows the power provided to the seventh light-emitting subassembly depending on the target color temperature. Note that each transfer function only has non-zero values for the range of target color temperatures between the nearest CCTs of the other light-emitting subassemblies.

A controller of the multi-die wide-range tunable-white LED for use with the transfer functions shown in FIG. 7 functions similarly to the controller for the apparatus of FIG. 1A or 1B. It may determine which two light-emitting subassemblies the target color temperature lies between and interpolate between those two CCTs to determine the power levels for those two light-emitting subassemblies, setting the power level for the other five light-emitting subassemblies to zero. The multi-die wide-range tunable-white LED used with the transfer functions of FIG. 7 can provide a CCT over the entire range of 1000K to 10000K, while an apparatus of FIG. 1A or 1B is limited to a range of 1000K to 3200K.

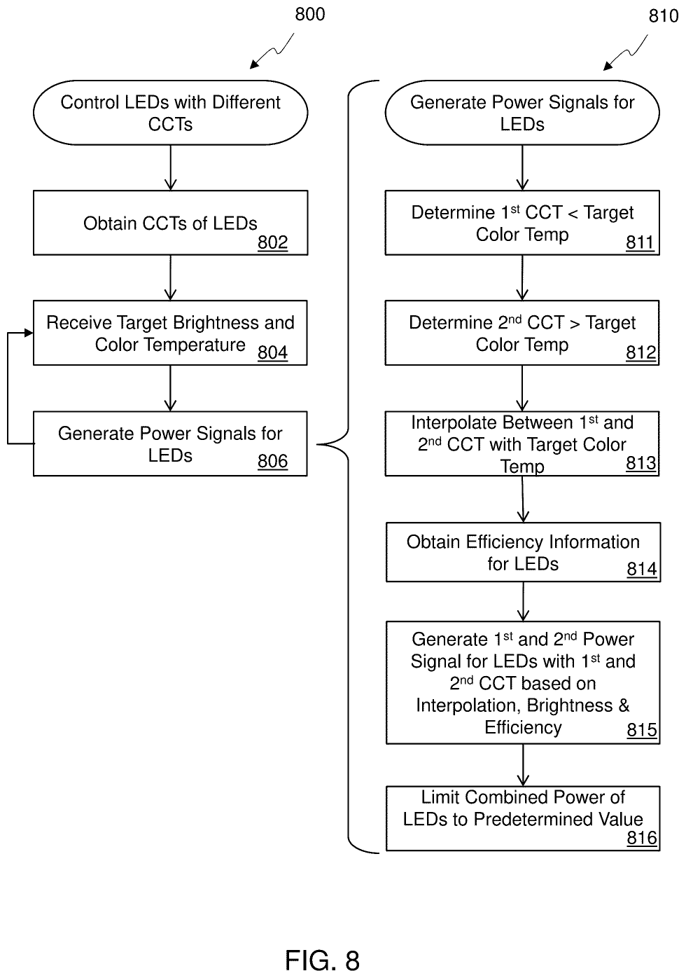

FIG. 8 shows two flow charts 800, 810 that together describe an example method of controlling a multi-die tunable-white LED. Flow chart 800 shows a method for controlling three or more light sources having different correlated color temperatures (CCT). The method includes obtaining 802 three or more CCT values respectively corresponding to three or more light sources. The CCT values may be hard-wired into a controller that implements the method, set in non-volatile memory during the manufacturing process, or programmed into the controller at installation and saved into volatile or non-volatile memory. Any appropriate mechanism can be used to obtain the CCT values.

The method continues with receiving 804 a target brightness and a target color temperature. The target brightness and target color temperature may be received through inputs of the controller. The inputs may be PWM encoded using separate lines for the target brightness and target color temperature, provided as analog signal levels on separate inputs or time-domain multiplexed on a single input, provided as digital data through one or more serial inputs or parallel inputs, or provided using any other appropriate mechanism.

Three or more power signals are generated 806, respectively, for the three or more light sources based on the target brightness, the target color temperature, and the three or more CCT values. Over time, new target brightness and target color temperature values may be received 804, causing new levels for the power signals to be generated 806.

Flow chart 810 provides more detail for how power signals are generated 806. Once a target color temperature is received 804, the CCTs for the light sources are compared to the target color temperature and a first CCT value of the three or more CCT values is determined 811 that is less than the target color temperature. The first CCT value may be the CCT value that is closest to the target color temperature while being less than the target color temperature. In addition, a second CCT value of the three or more CCT values is determined 812 that is greater than the target color temperature. The second CCT value may be the CCT value that is closest to the target color temperature while being greater than the target color temperature.

The method continues by linearly interpolating 813 between the first CCT value and the second CCT value using the target color temperature to determine a first power value and a second power value. In some implementations, first efficiency information for the first light source and second efficiency information for the second light source is obtained 814. The first efficiency information may include a representation of a first curve and the second efficiency information may include a representation of a second curve. The first efficiency information may identify a first maximum value, and the second efficiency information may identify a second maximum value that is different than the first maximum value in some implementations.

The first efficiency information and the target brightness may be used to adjust the first power value, and the second efficiency information and the target brightness may be used to adjust the second power value. A non-zero first power signal of the three or more power signals corresponding to a first light source of the three or more light sources and a non-zero second power signal of the three or more power signals corresponding to a second light source of the three or more light sources that corresponds to the second CCT value may then be generated 815 based on the adjusted first power value and adjusted second power value, respectively. Power signals providing no power for other power signals of the three or more power signals that are not the first power signal and the second power signal are also be generated. The controller may also limit 816 the combined power of the three or more power signals to a predetermined maximum value in some implementations.

The following paragraphs provide example implementations.

Example 1. A light-emitting apparatus comprising: a first light-emitting subassembly to emit light at a first correlated color temperature (CCT) comprising a first phosphor and a first light-emitting device positioned to excite the first phosphor; a second light-emitting subassembly to emit light at a second CCT comprising a second phosphor and a second light-emitting device positioned to excite the second phosphor; a third light-emitting device to emit light at a third CCT. a control circuit configured to provide first controlled power to the first light-emitting device, second controlled power to the second light-emitting device, and third controlled power to the third light-emitting device; and one or more inputs to the control circuit to provide power, brightness information, and target color temperature information to the control circuit.

Example 2. The light-emitting apparatus of example 1, the one or more inputs further comprising: a brightness input; a color temperature input; and a common power input.

Example 3. The light-emitting apparatus of example 2, the common power input comprising a common anode or a common cathode for the brightness input and the color temperature input.

Example 4. The light-emitting apparatus of example 2, wherein the brightness input and the color temperature input are pulse-width modulated to respectively provide the brightness information and the target color temperature information to the control circuit.

Example 5. The light-emitting apparatus of example 1, the one or more inputs further comprising: a serial input to provide the brightness information and the target color temperature information; a power input; and a ground input.

Example 6. The light-emitting apparatus of example 1, wherein the first controlled power, the second controlled power, and the third controlled power are based on the brightness information, the target color temperature information, the first CCT, the second CCT, and the third CCT.

Example 7. The light-emitting apparatus of example 1, further comprising: a strip of flexible material to which the first light-emitting subassembly, the second light-emitting subassembly, the third light-emitting device and the control circuit are affixed; wherein the first light-emitting device, the second light-emitting device, and the third light-emitting device are light-emitting diodes (LEDs).

Example 8. The light-emitting apparatus of example 1, wherein the first phosphor is further formulated to filter the light received from the first light-emitting device; and the second phosphor is further formulated to filter the light received from the second light-emitting device.

Example 9. The light-emitting apparatus of example 1, further comprising: a third light-emitting subassembly mounted to the substrate and comprising the third light-emitting device, a fourth phosphor and a fourth light-emitting device; wherein the third light-emitting device and the fourth light-emitting device are positioned provide their respective light to the fourth phosphor which is formulated to emit light at a fourth CCT in response to receiving light from the fourth light-emitting device and pass the light from the third light-emitting device.

Example 10. A controller for a light-emitting apparatus, the controller comprising: one or more inputs to provide brightness information, and target color temperature information; a converter to generate a first power level, a second power level, and a third power level based on the brightness information, the target color temperature information, a first light-emitter characteristic, a second light-emitter characteristic, and a third light-emitter characteristic; a first output to provide a first power signal based on the first power level; a second output to provide a second power signal based on the second power level; and a third output to provide a third power signal based on the third power level.

Example 11. The controller of example 10, the one or more inputs comprising a serial input.

Example 12. The controller of example 10, the one or more inputs comprising a brightness input and a color temperature input to receive pulse-width modulated signals to that respectively provide the brightness information and the target color temperature information.

Example 13. The controller of example 10, wherein the first light-emitter characteristic comprises a first correlated color temperature (CCT), the second light-emitter characteristic comprises a second CCT, and the third light-emitter characteristic comprises a third CCT.

Example 14. The controller of example 13, wherein the first light-emitter characteristic, the second light-emitter characteristic, and the third light-emitter characteristic each further comprise efficiency information.

Example 15. The controller of example 13, wherein the converter determines that the target color temperature information is between the first CCT and the second CCT and in response, generates a third power level of 0 and generates the first power level and the second power level based on the target color temperature information, the first CCT, and the second CCT, without use of the third CCT.

Example 16. The controller of example 15, wherein the first power level and the second power level are generated based on a linear interpolation of the target color temperature information between the first CCT and the second CCT.

Example 17. The controller of example 10, wherein the converter limits a sum of the first power level, the second power level, and the third power level to a predetermined maximum.

Example 18. The controller of example 10, wherein the first light-emitter characteristic, the second light-emitter characteristic, and the third light-emitter characteristic each comprise a spectral wavelength and efficiency information.

Example 19. The controller of example 18, wherein the first light-emitter characteristic indicates a red LED emission, the second light-emitter characteristic indicates a green LED emission, and the third light-emitter characteristic indicates a blue LED emission.

Example 20. A method for controlling three or more light sources having different correlated color temperatures (CCT), the method comprising: obtaining three or more CCT values respectively corresponding to three or more light sources; receiving a target brightness and a target color temperature; and generating three or more power signals, respectively, for the three or more light sources based on the target brightness, the target color temperature, and the three or more CCT values.

Example 21. The method of example 20, further comprising: determining a first CCT value of the three or more CCT values that is less than the target color temperature; determining a second CCT value of the three or more CCT values that is greater than the target color temperature; generating a non-zero first power signal of the three or more power signals corresponding to a first light source of the three or more light sources that corresponds to the first CCT value; generating a non-zero second power signal of the three or more power signals corresponding to a second light source of the three or more light sources that corresponds to the second CCT value; and generating a power signal providing no power for other power signals of the three or more power signals that are not the first power signal and the second power signal.

Example 22. The method of example 21, further comprising: linearly interpolating between the first CCT value and the second CCT value using the target color temperature to determine a first power value and a second power value; adjusting the first power value and the second power value using the target brightness; generating the first power signal based on the adjusted first power value; and generating the second power signal based on the adjusted second power value.

Example 23. The method of example 22, further comprising: obtaining first efficiency information for the first light source; obtaining second efficiency information for the second light source; using the first efficiency information in the adjusting of the first power value; and using the second efficiency information in the adjusting of the second power value.

Example 24. The method of example 23, wherein the first efficiency information comprises a representation of a first curve and the second efficiency information comprises a representation of a second curve.

Example 25. The method of example 23, wherein the first efficiency information identifies a first maximum value, and the second efficiency information identifies a second maximum value that is different than the first maximum value.

Example 26. A multi-die light emitting diode (LED) assembly comprising: a substrate; a first light-emitting subassembly to emit light at a first correlated color temperature (CCT) mounted on the substrate and comprising a first phosphor and a first light-emitting device positioned to excite the first phosphor; a second light-emitting subassembly to emit light at a second CCT mounted on the substrate and comprising a second phosphor and a second light-emitting device positioned to excite the second phosphor; a third light-emitting subassembly mounted on the substrate and comprising a third light-emitting device to emit light at a third CCT, a fourth phosphor and a fourth light-emitting device; wherein the third light-emitting device and the fourth light-emitting device are positioned provide their respective light to the fourth phosphor which is formulated to emit light at a fourth CCT in response to receiving light from the fourth light-emitting device and pass the light from the third light-emitting device.

Example 27. The multi-die light emitting diode (LED) assembly of example 26,

wherein the substrate comprises a 5050 surface-mount device (SMD) package.

Example 28. The multi-die light emitting diode (LED) assembly of example 26, further comprising: a control circuit mounted on the substrate and configured to provide first controlled power to the first light-emitting device, second controlled power to the second light-emitting device, and third controlled power to the third light-emitting device; and one or more inputs to the control circuit to provide power, brightness information, and target color temperature information to the control circuit.

As used in this specification and the appended claims, the singular forms “a”, “an”, and “the” include plural referents unless the content clearly dictates otherwise. Furthermore, as used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

The description of the various embodiments provided above is illustrative in nature and is not intended to limit this disclosure, its application, or uses. Thus, different variations beyond those described herein are intended to be within the scope of embodiments. Such variations are not to be regarded as a departure from the intended scope of this disclosure. As such, the breadth and scope of the present disclosure should not be limited by the above-described exemplary embodiments but should be defined only in accordance with the following claims and equivalents thereof.

We claim as follows:

1. An apparatus comprising:
a first light-emitting subassembly to emit light at a first correlated color temperature (CCT) comprising a first phosphor and a first light-emitting device positioned to excite the first phosphor;
a second light-emitting subassembly to emit light at a second CCT comprising a second phosphor and a second light-emitting device positioned to excite the second phosphor;
a third light-emitting device to emit light at a third CCT.
a control circuit configured to provide first controlled power to the first light-emitting device, second controlled power to the second light-emitting device, and third controlled power to the third light-emitting device; and
one or more inputs to the control circuit to provide power, brightness information, and target color temperature information to the control circuit.

2. The apparatus of claim 1, the one or more inputs further comprising:
a brightness input;
a color temperature input; and
a common power input.

3. The apparatus of claim 1, the one or more inputs further comprising:
a serial input to provide the brightness information and the target color temperature information;
a power input; and
a ground input.

4. The apparatus of claim 1, wherein the first controlled power, the second controlled power, and the third controlled power are based on the brightness information, the target color temperature information, the first CCT, the second CCT, and the third CCT.

5. The apparatus of claim 1, further comprising:
a strip of flexible material to which the first light-emitting subassembly, the second light-emitting subassembly, the third light-emitting device and the control circuit are affixed;
wherein the first light-emitting device, the second light-emitting device, and the third light-emitting device are light-emitting diodes (LEDs).

6. The apparatus of claim 1, further comprising:
a third light-emitting subassembly mounted to the substrate and comprising the third light-emitting device, a fourth phosphor and a fourth light-emitting device;
wherein the third light-emitting device and the fourth light-emitting device are positioned provide their respective light to the fourth phosphor which is formulated to emit light at a fourth CCT in response to receiving light from the fourth light-emitting device and pass the light from the third light-emitting device.

7. An apparatus comprising:
one or more inputs to provide brightness information, and target color temperature information;
a converter to generate a first power level, a second power level, and a third power level based on the brightness information, the target color temperature information, a first light-emitter characteristic, a second light-emitter characteristic, and a third light-emitter characteristic;
a first output to provide a first power signal based on the first power level;
a second output to provide a second power signal based on the second power level; and
a third output to provide a third power signal based on the third power level.

8. The apparatus of claim 7, the one or more inputs comprising a serial input.

9. The apparatus of claim 7, the one or more inputs comprising a brightness input and a color temperature input to receive pulse-width modulated signals to that respectively provide the brightness information and the target color temperature information.

10. The apparatus of claim 7, wherein the first light-emitter characteristic comprises a first correlated color temperature (CCT), the second light-emitter characteristic comprises a second CCT, and the third light-emitter characteristic comprises a third CCT.

11. The apparatus of claim 10, wherein the first light-emitter characteristic, the second light-emitter characteristic, and the third light-emitter characteristic each further comprise efficiency information.

12. The apparatus of claim 10, wherein the converter determines that the target color temperature information is between the first CCT and the second CCT and in response, generates a third power level of 0 and generates the first power level and the second power level based on the target color temperature information, the first CCT, and the second CCT, without use of the third CCT.

13. The apparatus of claim 12, wherein the first power level and the second power level are generated based on a linear interpolation of the target color temperature information between the first CCT and the second CCT.

14. The apparatus of claim 7, wherein the converter limits a sum of the first power level, the second power level, and the third power level to a predetermined maximum.

15. A method for controlling three or more light sources having different correlated color temperatures (CCT), the method comprising:
obtaining three or more CCT values respectively corresponding to three or more light sources;
receiving a target brightness and a target color temperature; and
generating three or more power signals, respectively, for the three or more light sources based on the target brightness, the target color temperature, and the three or more CCT values.

16. The method of claim 15, further comprising:
determining a first CCT value of the three or more CCT values that is less than the target color temperature;
determining a second CCT value of the three or more CCT values that is greater than the target color temperature;
generating a non-zero first power signal of the three or more power signals corresponding to a first light source of the three or more light sources that corresponds to the first CCT value;
generating a non-zero second power signal of the three or more power signals corresponding to a second light source of the three or more light sources that corresponds to the second CCT value; and
generating a power signal providing no power for other power signals of the three or more power signals that are not the first power signal and the second power signal.

17. The method of claim 16, further comprising:
linearly interpolating between the first CCT value and the second CCT value using the target color temperature to determine a first power value and a second power value;
adjusting the first power value and the second power value using the target brightness;
generating the first power signal based on the adjusted first power value; and
generating the second power signal based on the adjusted second power value.

18. The method of claim 17, further comprising:
obtaining first efficiency information for the first light source;
obtaining second efficiency information for the second light source;
using the first efficiency information in the adjusting of the first power value; and
using the second efficiency information in the adjusting of the second power value.

19. The method of claim 18, wherein the first efficiency information comprises a representation of a first curve and the second efficiency information comprises a representation of a second curve.

20. The method of claim 18, wherein the first efficiency information identifies a first maximum value, and the second efficiency information identifies a second maximum value that is different than the first maximum value.
